(19) United States
(12) Patent Application Publication
(10) Pub. No.: US 2012/0242074 A1
(43) Pub. Date: Sep. 27, 2012

(54) FORGERY-RESISTANT DOCUMENT, PARTICULARLY FOR SECURITIES AND THE LIKE

(75) Inventor: Paolo Tamagnini, Fabriano (IT)

(73) Assignee: FEDRIGONI S.P.A., Verona (IT)

(21) Appl. No.: 13/513,382

(22) PCT Filed: Nov. 12, 2010
(86) PCT No.: PCT/EP2010/067392

§ 371 Date: Jun. 1, 2012

(30) Foreign Application Priority Data
Dec. 4, 2009 (IT) VR2009A000208

(51) Int. Cl. B42D 15/00

(52) U.S. Cl. 283/85

(57) ABSTRACT

A forgery-resistant document, particularly for securities, which comprises a sheet- like medium having at least one first region which has at least one first graphic marking which is visible in transmitted light, and at least one second region which has at least one second graphic marking visible in transmitted light or in reflected light and different from the first graphic marking, the first graphic marking cooperating with the second graphic marking as a consequence of the at least partial superimposition of the first region with the second region so as to provide at least one graphic representation that is visible in transmitted light.

The present invention refers to a forgery-resistant document, particularly for securities and the like.

### BACKGROUND OF THE INVENTION

As is known, a problem that is currently very pressing relates to the anti-falsification of documents such as securities, cheques, banknotes and the like and also to their forgery.

Currently a number of different techniques have been developed in order to attempt to make the falsification of documents increasingly difficult, such as, for example, the use of watermarked paper which depicts engraved symbols or figures in such a way as to be visible only in transmitted light (i.e. only when held up against the light), together with the use of security threads, holograms in the form of strips or patches, and silk-screen stripes, to name but a few.

Reproduction of a banknote therefore requires the awareness of, and the effective possibility of reproducing, all the procedures with which such security elements are implemented.

Since the main requirement on such security elements is substantially that of not being easy to reproduce, manufacturing procedures have been developed which involve a sequence of extremely elaborate phases and, often, the use of elements with peculiar chemical or physical characteristics.

As noted above, these procedures make it possible to obtain effects, typically optical effects, that are exceptionally difficult to reproduce exactly and which, therefore, are capable of being used to distinguish an original banknote from a forged one, a strategy which, inter alia, is adopted for various other types of security paper as well.

### SUMMARY OF THE INVENTION

The aim of the present invention is to solve the above-mentioned problem, by providing a forgery-resistant document, particularly for securities and the like, that has a degree of security considerably superior to that of the known art.

Within this aim, an object of the present invention is to provide a forgery-resistant document, particularly for securities and the like, which, owing to its peculiar implementation characteristics, is capable of offering the highest guarantees of reliability and security in use.

Another object of the present invention is to provide a forgery-resistant document, particularly for securities and the like, that can be made with technologies which are in and of themselves known and which, in addition, is competitive from a purely economic point of view.

This aim, as well as these and other objects which will become better apparent hereinafter, are achieved by a forgery-resistant document, particularly for securities and the like, characterised in that it comprises a sheet-like medium, generally made from paper, which comprises at least one first region having at least one first graphic marking which is visible in transmitted light and at least one second region which has at least one second graphic marking visible in transmitted light and different from said first graphic marking, the first graphic marking cooperating with the second graphic marking as a consequence of the at least partial superimposition of the first region with the second region so as to provide at least one graphic representation that is visible in transmitted light.

### BRIEF DESCRIPTION OF THE DRAWINGS

Further characteristics and advantages of the invention will become better apparent from the following detailed description of some preferred, but not exclusive, embodiments of a forgery-resistant document, particularly for securities or the like, according to the present invention, illustrated by way of non-limiting example in the accompanying drawings, wherein:

FIG. 1 schematically shows a perspective view of a banknote being folded;

FIG. 2 is a perspective view of a folded banknote which is observable in transmitted light;

FIG. 3 is a view similar to the previous one in which the two superimposed portions of the banknote have been moved with respect to each other with respect to the condition shown in FIG. 2;

FIG. 4 is a plan view of the first region and of the second region of a banknote;

FIG. 4a is an enlarged scale view of a portion of the second region shown in FIG. 4;

FIGS. 5 and 6 are enlarged scale views of a first graphic representation and a second graphic representation which are visible as a consequence of respective superimpositions of the first region and the second region of the forgery-resistant document.

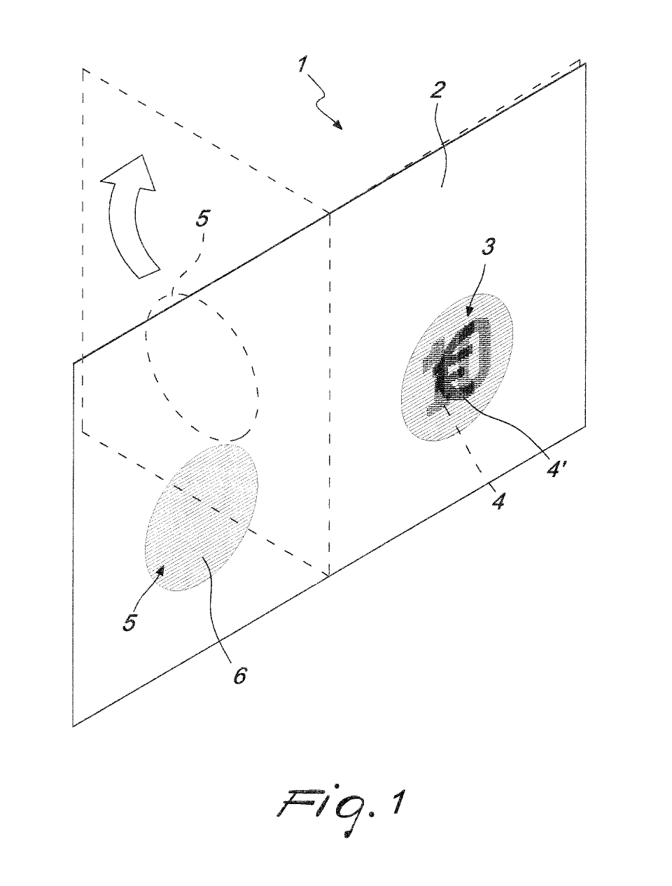

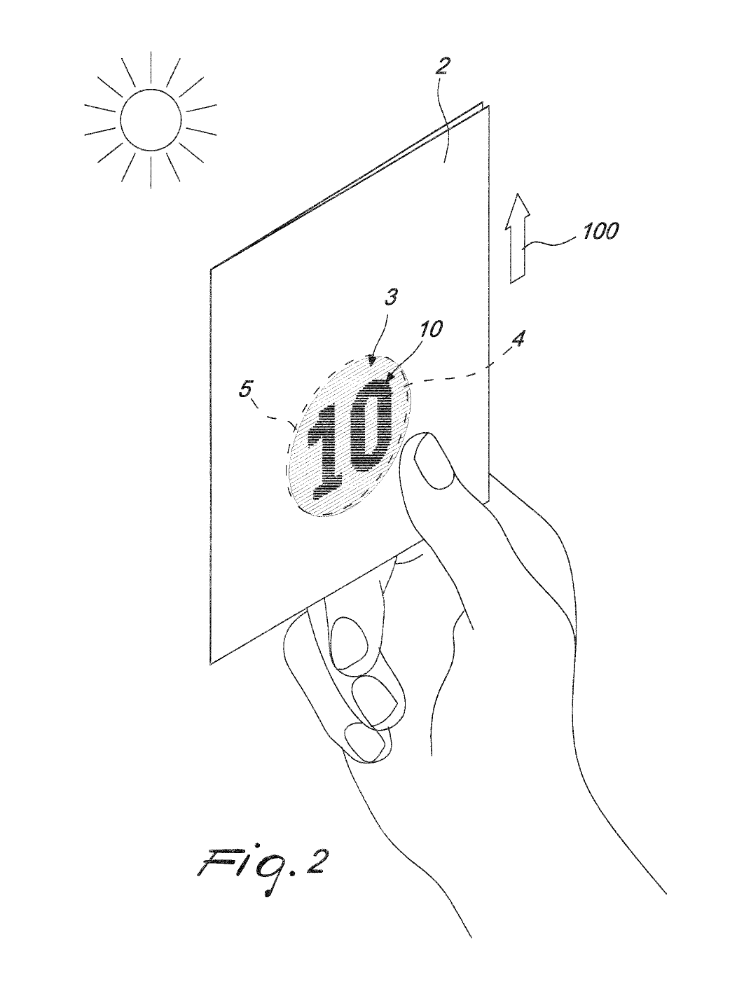

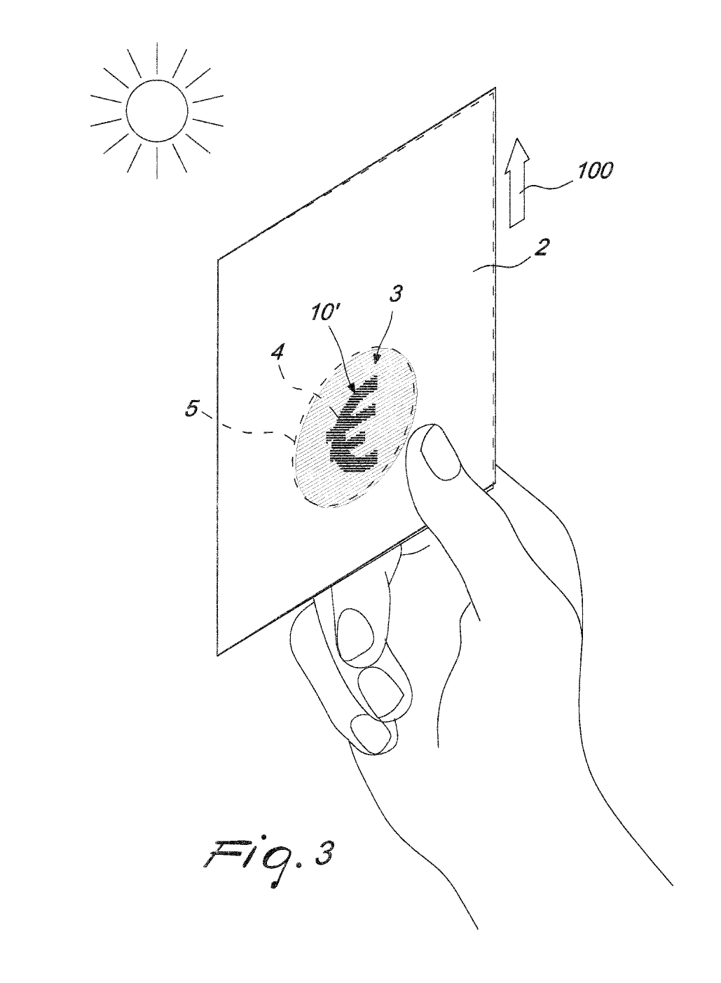

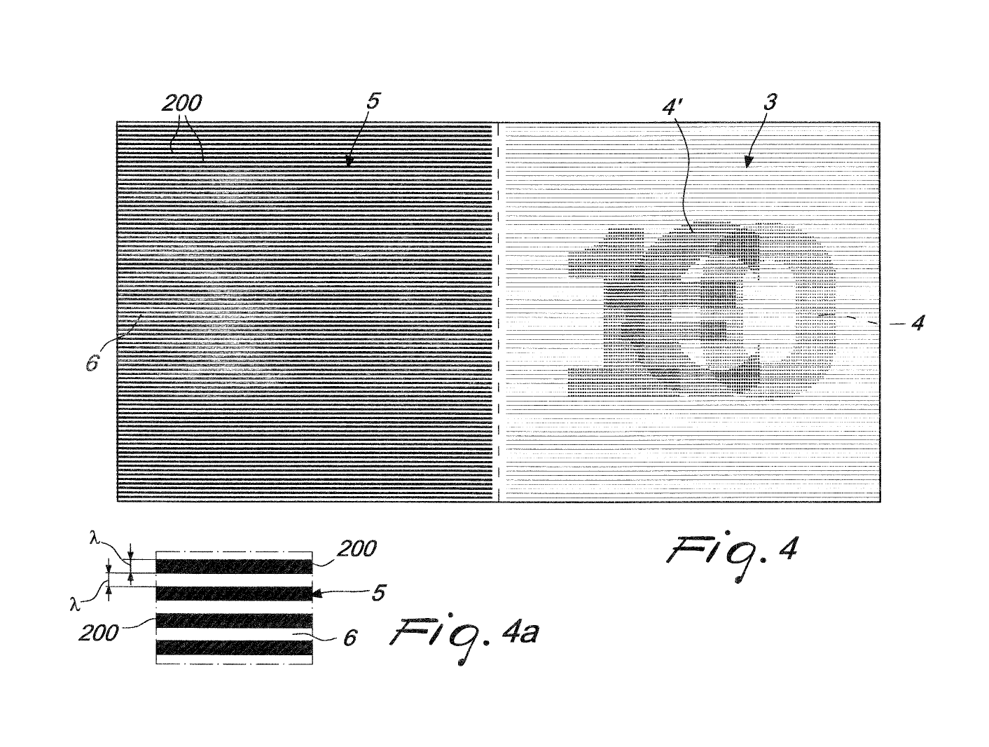

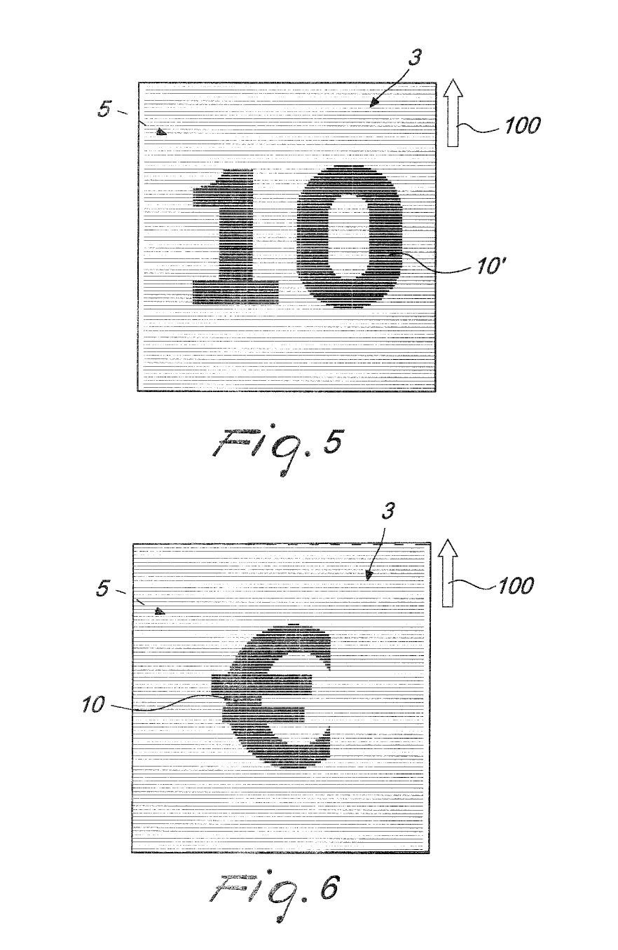

### DESCRIPTION OF THE PREFERRED EMBODIMENTS

In the embodiments that follow, individual characteristics shown in relation to specific examples may in reality be interchanged with other, different characteristics, existing in other embodiments.

With reference to the figures, the present invention refers to a forgery-resistant document, indicated generally with the reference numeral 1, particularly for securities, banknotes and the like.

The document 1 comprises, in particular, a sheet-like medium 2, generally made from paper, which has at least one first region 3 having at least one first graphic marking 4 which is visible in transmitted light, and at least one second region 5 which has at least one second graphic marking 6 visible in transmitted light or in reflected light.

The second graphic marking 6 is different from the first graphic marking 4.

According to the present invention, the first graphic marking 4 cooperates with the second graphic marking 6 as a consequence of the at least partial superimposition of the first region 3 with respect to the second region 5 so as to provide at least one graphic representation 10 which is visible in transmitted light.

The first graphic marking 4 and/or the second graphic marking 6 are, advantageously, constituted by at least one respective watermark.

Merely for exemplary purposes, it is possible to have the first graphic marking 4 comprise a component, undefined on its own, of the graphic representation 10 which, as explained, is completed by the superimposition of the second graphic marking 6 which, typically, can be constituted by a plurality of mutually spaced completion lines.

Advantageously, the first graphic marking 4 and the second graphic marking 6 have, when they are superimposed, an interaction that is constructive in nature, or which is destructive in nature, so as to make the graphic representation 10 visible in transmitted light.

According to a particularly important aspect of the present invention, the first region 3 is provided with a first first graphic marking 4 and with a second first graphic marking 4′.

It has been found that, by providing the second graphic marking 6 by means of a regular alternation of light and dark regions (for example of 200 lines placed at a determined distance X, and with a width which is also X) it is possible, by moving the first region 3 relative to the second region 5 along a direction of movement 100, to separately and alternately see a first graphic representation 10 (completion of the first first graphic marking 4) and a second graphic representation 10′ (completion of the second first graphic marking 4′).

Advantageously, the direction of movement 100 is substantially perpendicular to the direction of extension of the lines 200.

In particular, starting from a predetermined position of at least partial superimposition of the first region 3 and the second region 5, if we move the second region 5 with respect to the first region 3 along the direction 100 by a distance of 2n (where n=0, 1, 2, 3 . . . etc.) times the width of a light line or of a dark line (X), we will always see the first graphic representation 10, whereas if we move the second region 5 with respect to the first region 3 along the direction 100 by a distance of 2n+1 (where n=0, 1, 2, 3 . . . etc.) times the width of a light line or of a dark line (X), we will always see the second graphic representation 10′.

It therefore appears evident that the precision with which the first graphic markings (4, 4′ etc.) and also the second graphic marking 6 are reproduced in the watermark constitutes an important factor for the visibility and recognition of the graphic representations (10, 10′). For this reason it is advisable to ensure that the first graphic markings (4, 4′) and the second graphic marking 6 be created together and by the same apparatus. Indeed, small differences in the distance between a light line and a dark line (X) or between the various parts of the first graphic markings (4, 4′) would no longer permit the identification and recognition of the two separate images.

The second graphic marking 6 can be formed, inter alia, by a grid structure which is made of lines mutually spaced apart and perpendicular and which, owing to the alternation of points which are more transparent and points which are more opaque, allows the recognition of the various different graphic representations (10, 10′) as a function of the relative position between the second graphic marking 6 and the first graphic markings (4, 4′).

Advisably, locator means can be provided which are adapted to make it possible to correctly superimpose the first region 3 and the second region 5. According to a possible embodiment, the first and the second graphic representations (10, 10′) are visible, alternately, as a consequence of moving the first region 3 with respect to the second region 5 owing to the moire effect, thus generating movement effects as well.

From the foregoing description and explanation it can be seen that the invention achieves the intended aims.

The invention thus conceived is susceptible of numerous modifications and variations, all of which are within the scope of the appended claims.

Thus, for example, instead of the two watermarks, 3 or 5, one of them can also be constituted by equivalent structures obtained by means of print, plastic screens or other material adapted for the purpose.

According to another embodiment, the first region 3 and/or the second region 5 can be provided by means of the use of a watermarked region partially engraved for example by means of laser engraving devices or by means of micro-perforation procedures.

Moreover, the direction of movement 100 can be made to be, as shown in the figures, parallel to the fold line or, for example, perpendicular to it.

Moreover all the details can be substituted by other, technically equivalent elements.

In practice the materials employed as well as the dimensions and the contingent shapes may be any, according to requirements.

The disclosures in Italian Patent Application No. VR2009A000208 from which this application claims priority are incorporated herein by reference.

1-9. (canceled)

10. A forgery-resistant document, particularly for securities or the like, comprising a sheet-like medium which comprises at least one first region, having at least one first graphic marking which is visible in transmitted light, and at least one second region, having at least one second graphic marking, which is visible in transmitted light or in reflected light and is different from said first graphic marking, said first graphic marking cooperating with said second graphic marking as a consequence of the at least partial superimposition of said first region with respect to said second region so as to provide at least one graphic representation that is visible in transmitted light.

11. The forgery-resistant document according to claim 10, wherein said at least one first graphic marking and/or said at least one second graphic marking comprise at least one respective watermark.

12. The forgery-resistant document according to claim 10, wherein said at least one first graphic marking and said at least one second graphic marking have, when they are superimposed, an interaction of the constructive type so as to provide said at least one graphic representation that is visible in transmitted light.

13. The forgery-resistant document according to claim 10, wherein said at least one first graphic marking and said at least one second graphic marking have, when they are superimposed, an interaction of the destructive type to provide said at least one graphic representation that is visible in transmitted light.

14. The forgery-resistant document according to claim 10, further comprising locator means adapted to allow correct superimposition of said first region and said second region.

15. The forgery-resistant document according to claim 10, wherein said first region comprises at least two first graphic markings, which cooperate respectively with said at least one second graphic marking to provide respectively a first graphic representation and a second graphic representation which are visible in transmitted light.

16. The forgery-resistant document according to claim 15, wherein said first and second graphic representations are visible alternately as a consequence of the movement of said first region with respect to said second region along at least one first direction of motion.

17. The forgery-resistant document according to claim 15, wherein said first and second graphic representations are visible alternately as a consequence of the movement of said first region with respect to said second region by the moire effect, also generating motion effects.

18. The forgery-resistant document according to claim 10, wherein said second graphic marking comprises a regular alternation of lines arranged at a specific distance k whose width also is λ, said direction of motion being substantially perpendicular to the direction of extension of said lines.
